(19) United States
(12) Patent Application Publication
(10) Pub. No.: US 2010/0119759 A1
(43) Pub. Date: May 13, 2010

(54) ADHESIVE FILM FOR PRODUCING SEMICONDUCTOR DEVICE

(75) Inventors: Hiroyuki Kondo, Osaka (JP); Yasuhiro Amano, Osaka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: NITTO DENKO CORPORATION, Ibaraki-shi (JP)

(21) Appl. No.: 12/593,004

(22) PCT Filed: Oct. 22, 2007
(86) PCT No.: PCT/JP2007/070517

§ 371 Date: Sep. 25, 2009

(30) Foreign Application Priority Data
Mar. 27, 2007 (JP) 2007-081745

(51) Int. Cl. B32B 27/04

(52) U.S. Cl. 428/41.3; 428/40.2

(57) ABSTRACT

An adhesive film for manufacturing a semiconductor device, which is to be finally removed in the method for manufacturing a semiconductor device, can be suitably used in the manufacture of a semiconductor device having a so-called standoff, wherein a part of a conductor projects from an encapsulation resin, and has excellent wire bonding property. The adhesive film includes a thermosetting adhesive layer, and the thermosetting adhesive layer includes a layered clay mineral, wherein the adhesive film is used in a method for manufacturing a semiconductor device including (a) embedding at least a part of a conductor in the adhesive film; (b) mounting a semiconductor chip on the conductor; (c) connecting the semiconductor chip to the conductor; (d) encapsulating the semiconductor chip with an encapsulation resin; and (e) removing the adhesive film therefrom.

### TECHNICAL FIELD

The present invention relates to an adhesive film for manufacturing a semiconductor device.

### BACKGROUND ART

In recent years, in the techniques of mounting LSI (Large Scale IC), CSP (Chip Size/Scale Package) techniques have been remarked. Of the techniques mentioned above, a package in the form in which a lead end is incorporated into the internal of the package as represented by a QFN (Quad Flat Non-leaded package) is one of the package forms especially remarked from the aspects of miniaturization and high integration. Among the methods for manufacturing a QFN as described above, in recent years, a manufacturing method in which plural chips for QFN are arranged in order on a die pad in the package pattern region of the lead frame, and encapsulated in a single batch with an encapsulation resin within cavities of a die, and thereafter cut out to individual QFN constructions by dicing, thereby dramatically improving the productivity per area of the lead frame has been especially remarked.

In the method for manufacturing QFN comprising batch-encapsulating plural semiconductor chips as described above, a region clamped with a molding die upon the resin encapsulation is only in the outside of the resin encapsulation region, which is further spread outside of the package pattern region. Therefore, in the package pattern region, especially in its central part, the outer lead side cannot be pressed to the molding die with a sufficient pressure, thereby making it very difficult to prevent leakage of the encapsulation resin to the outer lead side, whereby making it more likely to cause a disadvantage that a terminal or the like of QFN is covered with the resin.

In view of the above, in the method for manufacturing a QFN, there has been proposed a method for preventing leakage of an encapsulation resin to an outer side, comprising adhering an adhesive tape to an outer pad side of the lead frame, thereby giving a sealing effect by the masking of the adhesive tape (see Patent Publication 1). In this method, the adhesive tape is adhered together to the outer pad side of the lead frame in an initial stage, and thereafter adhering together after going through a mounting step of semiconductor chips and a wire bonding step until an encapsulating step with an encapsulation resin.

Further, in recent years, there have been proposed a method for manufacturing a so-called leadless semiconductor device in which the conductor is formed by adhering together a copper foil to a backing and etching the conductor for the purpose of further thinning of the semiconductor device (see Patent Publication 2), and a method of forming a conductor on an adhesive sheet (see Patent Publication 3). According to the above methods, since the conductor is formed on a backing, the conductor can be made thinner. Also, there is little abrasion or the like of a blade during dicing because it is not necessary to cut the lead frame in cases where semiconductor devices molded with an encapsulation resin are obtained in individual pieces.

### Patent Publication 1: Japanese Patent-Laid Open No. 2000-294580

Patent Publication 2: Japanese Patent-Laid Open No. Hei 9-252014

### Patent Publication 3: Japanese Patent-Laid Open No. 2005-183734

### DISCLOSURE OF THE INVENTION

### Problems to be Solved by the Invention

However, in the form as described in Patent Publication 3, partially formed conductive parts are only fused on an adhesive, but not bonded with the outer pad as in QFN. Therefore, there is a disadvantage that the conductive parts are resonated to an impact accompanying ultrasonic vibrations during the wire bonding step, thereby lowering the property of wire bonding.

An object of the present invention is to provide an adhesive film for manufacturing a semiconductor device, which is to be finally removed in the method for manufacturing a semiconductor device, can be suitably used in the manufacture of a semiconductor device that is leadless and has a so-called standoff, wherein a part of a conductor projects from an encapsulation resin, and has excellent wire bonding property.

### Means to Solve the Problems

The present inventors have intensively studied in order to solve the conventional disadvantages mentioned above. As a result, the present inventors have found that the above object can be accomplished by containing a layered clay mineral in a thermosetting adhesive layer. The present invention has been accomplished thereby.

Specifically, the present invention relates to an adhesive film for manufacturing a semiconductor device containing a thermosetting adhesive layer, characterized in that the thermosetting adhesive layer contains a layered clay mineral, wherein the adhesive film is used in a method for manufacturing a semiconductor device including the steps of:
(a) embedding at least a part of a conductor in the adhesive film;
(b) mounting a semiconductor chip on the conductor;
(c) connecting the semiconductor chip to the conductor;
(d) encapsulating the semiconductor chip with an encapsulation resin; and
(e) removing the adhesive film therefrom.

Since the layered clay mineral has a scaly form, especially the movement of the adhesive in a planar direction is controlled by containing the layered clay mineral in the thermosetting adhesive layer, as compared to a system containing a conventional spherical filler, whereby having an effect of preventing resonance to the vibration upon the wire bonding. Accordingly, when a semiconductor device is manufactured using an adhesive film using the thermosetting adhesive layer as mentioned above, high reliability on the wire bonding property can be obtained, thereby making it possible to improve its yield.

### Effects of the Invention

By using the adhesive film of the present invention, a semiconductor device having high mounting reliability, that is leadless and has a standoff can be stably manufactured.

### BEST MODE FOR CARRYING OUT THE INVENTION

The adhesive film for manufacturing a semiconductor device in the present invention is characterized in that the adhesive film is constituted by a heat-resistant backing layer and a thermosetting adhesive layer, and that the thermosetting adhesive layer contains a layered clay mineral.

The layered clay mineral refers to a clay mineral having a crystal structure in which clay layers mainly having two-dimensional structures are laminated. In addition, the layered clay mineral has not only properties of being allowed to swell by adding a solvent thereto, thereby increasing each of interlayer distances, but also properties of being capable of incorporating ions and molecules into the interlayer while keeping its structure. The layered clay mineral used in the present invention is not particularly limited, so long as the layered clay mineral can be dispersed in an adhesive. For example, the layered clay mineral includes smectite, saponite, sauconite, stevensite, hectorite, margarite, talc, phlogopite, chrysotile, chlorite, vermiculite, kaolinite, muscovite, xanthophyllite, dickite, nacrite, pyrophyllite, montmorillonite, beidellite, nontronite, tetrasilicic mica, sodium tenorite, antigorite, halloysite, and the like. The above-mentioned layered clay mineral may be any one of natural products or synthetic products. These layered clay minerals can be used alone or in admixture of two or more kinds. Especially, those having an average particle size D50 of preferably from 0.01 to 100 μm, and more preferably from 0.05 to 10 μm, and an aspect ratio (thickness of 1 nm) of preferably from 2000 to 10000 can be preferably used.

The layered clay mineral is contained in an amount of preferably from 1 to 10% by weight, and more preferably from 2 to 5% by weight, of the thermosetting adhesive layer. In addition, as the thermosetting adhesive, it is preferable to use a thermosetting adhesive containing a rubber component and an epoxy resin component. In that case, the layered clay mineral is contained in an amount of preferably from 5 to 20 parts by weight, and more preferably from 5 to 10 parts by weight, based on 100 parts by weight of the rubber component of the thermosetting adhesive. When the layered clay mineral is contained in an amount exceeding 20 parts by weight, the rubber component does not sufficiently exhibit the property as an adhesive. In addition, when the layered clay mineral is contained in an amount of less than 5 parts by weight, the amount is so small that the effects caused by adding the layered clay mineral are not sufficient.

The adhesive contained in the thermosetting adhesive layer includes various pressure-sensitive adhesives such as a silicone resin component and an acrylic resin component, and various adhesives such as an epoxy resin component/rubber component and a polyimide resin component. Among them, thermosetting adhesives containing a rubber component and an epoxy resin component are preferred, from the viewpoint of heat resistance and adhesion.

As the epoxy resin, a compound having two or more epoxy groups in one molecule is preferable. The epoxy resin includes, for example, glycidylamine epoxy resins, bisphenol F epoxy resins, bisphenol A epoxy resins, phenol novolak epoxy resins, cresol novolak epoxy resins, biphenyl epoxy resins, naphthalene epoxy resins, aliphatic epoxy resins, alicyclic epoxy resins, heterocyclic epoxy resins, spiro ring-containing epoxy resins, halogenated epoxy resins and the like. These epoxy resins can be used alone or in admixture of two or more kinds. Among them, bisphenol A epoxy resins are preferred.

The epoxy resin is contained in an amount of preferably from 40 to 95% by weight, and more preferably from 60 to 80% by weight, of the thermosetting adhesive, from the viewpoint of heat resistance and flexibility.

The epoxy equivalent of the epoxy resin is preferably 1000 g/eq or less, and more preferably 650 g/eq or less, from the viewpoint of preventing the adhesive from remaining on an adherend after removing the adhesive film.

The rubber component includes those conventionally used for epoxy resin adhesives, such as NBR (acrylonitrile-butadiene rubber) and an acrylic rubber. Among them, a copolymerized rubber containing an acrylonitrile moiety in a ratio of 5% by weight or more is preferable, and a carboxyl group modified-rubber is more preferable, from the viewpoint of easy removing the adhesive film after molding of an encapsulation resin. The rubber as described above includes an acrylonitrile-butadiene rubber such as “Nipol 1072J” (manufactured by ZEON CORPORATION), an acrylic rubber such as “PARACRON ME2000” (manufactured by Negami Chemical Industrial Co., Ltd.), and the like. Here, the copolymerization ratio of acrylonitrile is preferably from 5 to 30% by weight, and more preferably from 5 to 20% by weight.

The rubber component is contained in an amount of preferably from 5 to 40% by weight, and more preferably from 5 to 30% by weight, of the thermosetting adhesive, from the viewpoint of flexibility and heat resistance.

Further, it is preferable that a curing agent for curing the epoxy resin, that is a curing component is added to the adhesive. The curing agent includes phenol resins, various imidazole-based compounds and derivatives thereof, hydrazide compounds, dicyandiamide, microcapsulated products thereof and the like. For example, in a case where a phenol resin is contained as a curing agent, a phosphorus-based compound such as triphenylphosphine, or the like may also be used together as a curing accelerator.

Although the content of the curing agent in the adhesive cannot be necessarily set to a specific value because the content varies depending on the kinds thereof. For example, in a case where a phenol resin is used as the curing agent, it is preferable that the phenol resin is contained in an amount equivalent to the epoxy resin. Each of the other curing agent and the curing accelerator is contained in an amount of preferably from 0.05 to 10 parts by weight, and more preferably from 0.1 to 5 parts by weight, based on 100 parts by weight of the epoxy resin.

The thermosetting adhesive layer may properly further contain known various additives such as pigments, age resisters, silane coupling agents, and tackifying agents within the range in which various properties of the adhesive film would not be deteriorated. Among these additives, age resisters are effective for preventing deterioration at high temperatures.

The thickness of the thermosetting adhesive layer is preferably from about 1 to about 50 μm, and more preferably from about 5 to about 30 μm, from the viewpoint of film-forming property.

In addition, it is preferable that the adhesive film of the present invention can be easily removed from a semiconductor device without detaching a conductor from an encapsulation resin in the step (e) described later. From the above viewpoint, for example, in a case where a conductor is made of a copper foil, the adhesive strength of the thermosetting adhesive layer to the copper foil after curing is preferably from 1 to 20 N/20 mm, and more preferably from 3 to 10 N/20 mm, at 23° C.

The heat-resistant backing layer includes a layer using plastic backings such as polyesters, polyamides, polyphenylene sulfide, polyether imide, polyimides, and polyethylenenaphthalate, and porous backings thereof; paper backings such as glassine, bond paper, and Japanese paper; nonwoven backings such as cellulose, polyamides, polyesters, and aramid; metal film backings such as copper foil, aluminum foil, SUS foil, and nickel foil; and the like. Among them, the metal film backing layers are preferred from the viewpoint of ease in handling.

The thickness of the heat-resistant backing layer is preferably from about 10 to about 200 μm, and more preferably from 25 to 100 μm, from the viewpoint of handling property.

The adhesive film of the present invention can be manufactured by a method including the steps of applying a solution prepared by dissolving the adhesive in an organic solvent to a heat-resistant backing, and drying the solution with heating; a method including the steps of applying a dispersion prepared by dispersing the adhesive in an aqueous medium to a heat-resistant backing, and drying the dispersion with heating; or the like. As the organic solvent for dissolving the adhesive, a ketone-based solvent such as methyl ethyl ketone is preferred from the viewpoint of solubility.

An adhesive film containing plural layers of the thermosetting adhesive layers can be manufactured by a method including the step of forming adhesive layers on the heat-resistant backing layer one after another; a method including the step of adhering an adhesive layer separately prepared in advance using a removing laminate or the like to another adhesive layer or the heat-resistant backing layer; or appropriately combining these methods.

The shape of the adhesive film of the present invention is not particularly limited, and can take the form of sheet, tape or the like.

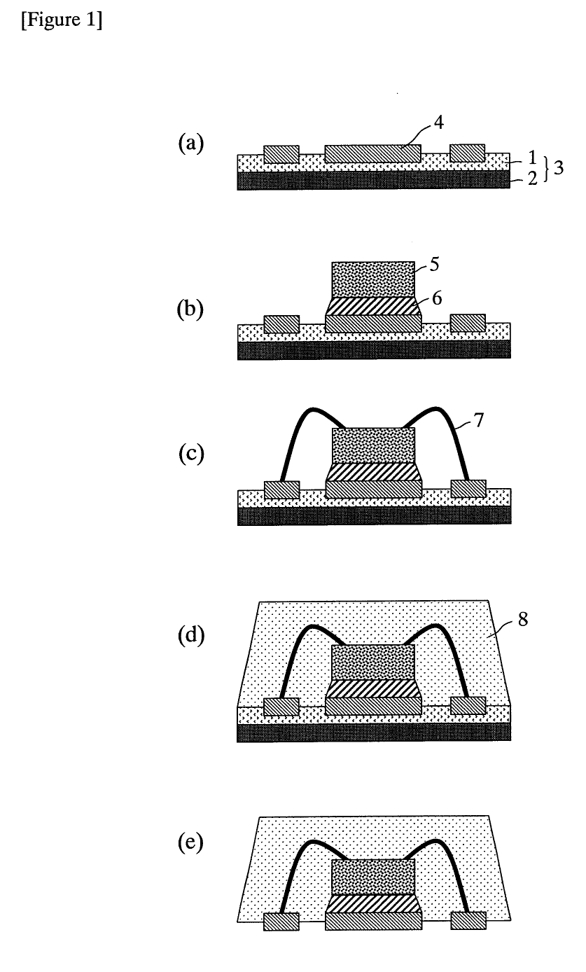

The adhesive film of the present invention can be used in a method for manufacturing a semiconductor device including the steps of:
(a) embedding at least a part of a conductor in the adhesive film;
(b) mounting a semiconductor chip on the conductor;
(c) connecting the semiconductor chip to the conductor;
(d) encapsulating the semiconductor chip with an encapsulation resin; and
(e) removing the adhesive film therefrom.
   The method for manufacturing a semiconductor device is not particularly limited as long as the method includes at least the steps (a) to (e) mentioned above. One embodiment thereof will be described hereinbelow, in accordance with FIG. 1.

The step (a) is a step of embedding at least a part of a conductor 4 in a thermosetting adhesive layer 1 of an adhesive film 3 of the present invention, wherein the adhesive film 3 contains the thermosetting adhesive layer 1 and a heat-resistant backing layer 2.

As the conductor to be used in the step (a), a lead frame can be used, for instance, in which openings are provided and conductive parts are arranged in a vertical-transverse matrix. The lead frame is made of a metal such as copper or an alloy containing copper, and has a terminal pattern of a CSP, of which electric contact portions may be coated (plated) with a material such as silver, nickel, palladium or gold in some cases. Usually, the thickness of the lead frame is preferably from about 5 to about 300 μm.

It is preferable that the lead frame is one in which each of the arrangement patterns of QFNs is systematically arranged, so that the lead frame can be easily divided in the subsequent dicing step. The form referred to as a matrix QFN or a MAP-QFN such as a form of the lead frame on which conductive parts are arranged in a vertical-transverse matrix is one of the preferable forms of lead frame in the present invention.

In the case of a general QFN, each of the substrate design on the lead frame comprises, for instance, terminal portions arranged around the opening, a die pad provided in the center of the opening, and a damber supporting the die pad at four corners of the opening.

The thickness of the conductor embedded in the adhesive film is preferably from about 5 to about 30% of the entire thickness of the conductor, from the viewpoint of increasing the mounting reliability of a semiconductor device having a standoff.

The conductor formed by embedding a part thereof in the adhesive film can be fixed by thermally curing the thermosetting adhesive layer.

The step (b) is a step of mounting a semiconductor chip 5 on the conductor 4. The mounting step of the semiconductor chip 5 can be carried out by, for example, bonding the side of the semiconductor chip 5 without forming any electrodes to the die pad side of the conductor 4, with an adhesive 6 or the like.

The step (c) is a step of connecting the semiconductor chip 5 to the conductor 4. Specifically, this is a step of electrically connecting the conductive parts of the conductor 4 and the electrodes of the semiconductor chip 5 through wires 7 or the like.

The step (d) is a step of encapsulating the semiconductor chip 5 with an encapsulation resin 8. The method of encapsulating the semiconductor chip 5 with the encapsulation resin 8 is not particularly limited. For example, the encapsulating method can be carried out using a mold in accordance with a usual transfer molding.

Here, the molded resin may be subjected to post-curing with heating after transfer molding if desired. Here, the post-curing with heating may be carried out either before or after the next step (e).

The step (e) is a step of removing the adhesive film 3 therefrom. The method of removing the adhesive film 3 is not particularly limited, and the method can be carried out by a method of peeling, or the like.

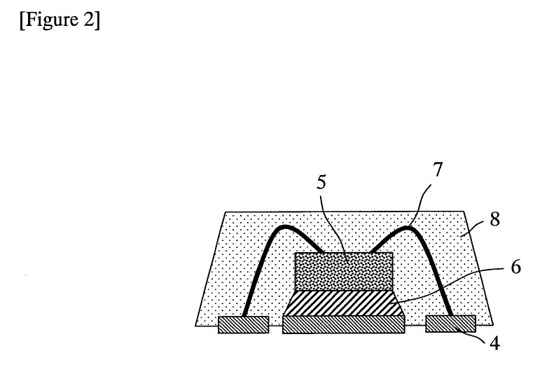

One embodiment of the semiconductor device manufactured through the steps described above is shown in FIG. 2. The semiconductor device has a so-called standoff wherein a part of the conductor 4 projects from the encapsulation resin 8.

### EXAMPLES

The present invention will be specifically described hereinbelow by Examples, and the present invention is not intended to limit to only the scope of the Examples.

### Example 1

Thirty parts by weight of acrylonitrile-butadiene rubber (“Nipol 1072J” manufactured by ZEON CORPORATION; content of acrylonitrile: 18% by weight), 1.5 parts by weight of a layered clay mineral (Somasif MAE, manufactured by CO-OP Chemical, swellable mica, average plane distance: 32 Å, average particle size (D50): 5 to 7 μm, aspect ratio (thickness: 1 nm): 5000 to 7000), 65 parts by weight of bisphenol A epoxy resin (“Epikote 828” manufactured by Japan Epoxy Resins Co., Ltd.; epoxy equivalent: 190 g/eq), and 5 parts by weight of imidazole (“C11Z” manufactured by Shikoku Kasei K.K.) were mixed together, and the components were dissolved in a methyl ethyl ketone solvent so as to have a solid content of 35% by weight, to give a thermosetting adhesive solution. The resulting thermosetting adhesive solution was applied onto a copper foil having a thickness of 100 μm as a heat-resistant backing, and then dried at 150° C. for 3 minutes, thereby forming a thermosetting adhesive layer having a thickness of 25 μm on the heat-resistant backing layer, to give an adhesive film. The adhesive strength of the adhesive film to the copper foil after curing the adhesive film was 9.1 N/20 mm at 23° C. Here, the adhesive strength is a value determined in accordance with the following methods.

[Determination Method for Adhesive Strength]

A copper foil having a thickness of 35 μm (“BHY-138T” manufactured by JAPAN ENERGY CORPORATION) was placed over the surface of the thermosetting adhesive layer of the adhesive film having a width of 20 mm and a length of 50 mm, and laminated together under the conditions of 120° C., 0.5 MPa, and 0.5 m/min. Thereafter, the laminate was allowed to stand in a hot-air oven at 150° C. for 1 hour, and the adhesive film was then pulled in the direction of 180° at a rate of 300 mm/min in atmosphere conditions of 23° C. and 65% RH. The median thereof is defined as an adhesive strength.

### Example 2

The adhesive film was produced in the same manner as in Example 1 except that the amount of a layered clay mineral added was changed to 3 parts by weight. The adhesive strength of the adhesive film to the copper foil after curing the adhesive film was 8.8 N/20 mm at 23° C.

### Example 3

The adhesive film was produced in the same manner as in Example 1 except that the amount of a layered clay mineral added was changed to 6 parts by weight. The adhesive strength of the adhesive film to the copper foil after curing the adhesive film was 9.5 N/20 mm at 23° C.

### Comparative Example 1

The adhesive film was produced in the same manner as in Example 1 by preparing the thermosetting adhesive solution at the same formulation as in Example 1 except that a layered clay mineral was not added. The adhesive strength of the adhesive film to the copper foil after curing the adhesive film was 8.3 N/20 mm at 23° C.

A semiconductor chip was bonded to a die pad portion of the lead frame using an epoxy phenol-based silver paste as an adhesive, and the adhesive was cured at 180° C. for 1 hour to mount the semiconductor chip on the die pad.

Next, the laminate of the adhesive film and the conductor was fixed to a heat block heated in the manner of subjecting the laminate to vacuum suction from the side of the adhesive film, and further the peripheral parts of the laminate were affixed by pressing with a wind damper. Electrodes of the semiconductor chips were connected to conductive parts of the lead frame with a 115 kHz wire bonder manufactured by SHINKAWA LTD., and whether or not the connection between the semiconductor chips and the conductive parts was successful under the following conditions while varying temperatures was confirmed.

### (W/B Conditions)

Gold line: diameter of 25 μm (manufactured by TANAKA PRECIOUS METALS, “GLD-25”)
Bonding force: Chip 40 gf, Conductive part 40 gf
US Frequency: Chip 500 mW, Conductive part 550 mW
Bonding time: Chip 8 ms, Conductive part 10 ms
Bonding temperatures: 175° C., 185° C., and 200° C.
Determination of success: Pull strength of 8 gf or more

In the adhesive films of Examples 1 to 3, the connection could be made in any temperatures.

However, in the adhesive film of Comparative Example 1, the connection failure was confirmed under the temperature conditions of 175° C.

### INDUSTRIAL APPLICABILITY

The adhesive film of the present invention can be used in the manufacture of a semiconductor device.

### BRIEF DESCRIPTION OF THE DRAWINGS

[FIG. 1] A schematic view of a series of steps showing one embodiment of the method for manufacturing a semiconductor device, using an adhesive film according to the present invention.

[FIG. 2] A cross-sectional view of one embodiment of a semiconductor device obtainable with an adhesive film according to the present invention.

### EXPLANATION OF NUMERICAL SYMBOLS

1 a thermosetting adhesive layer

2 a heat-resistant backing layer

3 an adhesive film

4 a conductor

5 a semiconductor chip

6 an adhesive

7 a wire

8 an encapsulation resin

1. An adhesive film for manufacturing a semiconductor device comprising a thermosetting adhesive layer, wherein the thermosetting adhesive layer comprises a layered clay mineral, wherein the adhesive film is used in a method for manufacturing a semiconductor device comprising:
(a) embedding at least a part of a conductor in the adhesive film;
(b) mounting a semiconductor chip on the conductor;
(c) connecting the semiconductor chip to the conductor;
(d) encapsulating the semiconductor chip with an encapsulation resin; and
(e) removing the adhesive film therefrom.

2. The adhesive film for manufacturing a semiconductor device according to claim 1, wherein the thermosetting adhesive layer further comprises a thermosetting adhesive comprising a rubber component and an epoxy resin component.

3. The adhesive film for manufacturing a semiconductor device according to claim 2, wherein the rubber component comprises an acrylonitrile-butadiene rubber or an acrylic rubber.

4. The adhesive film for manufacturing a semiconductor device according to claim 2, wherein the rubber component is contained in an amount of from 5 to 40% by weight of the thermosetting adhesive.

5. The adhesive film for manufacturing a semiconductor device according to claim 2, wherein the layered clay mineral is contained in an amount of from 5 to 20 parts by weight, based on 100 parts by weight of the rubber component.
